(19) United States
(12) Patent Application Publication
(10) Pub. No.: US 2025/0013022 A1
(43) Pub. Date: Jan. 9, 2025

(54) OPTICAL IMAGING LENS

(71) Applicant: E-PIN OPTICAL INDUSTRY CO., LTD, Taipei City (TW)

(72) Inventors: Chih-Hsiang Yin, Taipei City (TW); Cheng-Hung Hsieh, Taipei City (TW)

(73) Assignee: E-PIN OPTICAL INDUSTRY CO., LTD, Taipei City (TW)

(21) Appl. No.: 18/757,532

(22) Filed: Jun. 28, 2024

(30) Foreign Application Priority Data
Jul. 4, 2023 (TW) 112124858

(51) Int. Cl. G02B 13/24; G02B 1/11; G02B 9/62; G02B 13/06; G02B 13/18

(52) U.S. Cl. CPC G02B 13/24; G02B 1/11; G02B 9/62; G02B 13/06; G02B 13/18

(57) ABSTRACT

An optical imaging lens adapted to limited working distance is disclosed. The optical imaging lens includes a first, a second, a third, a fourth, a fifth, a sixth lens elements and an image sensing element sequentially along an optical axis from an object-side to an image-side. The first to the sixth lens element each includes an object-side surface facing toward an object-side as well as an image-side surface facing toward an image-side. The first lens element is a wide-angle lens element. The second to the sixth lens element are a combination of aspherical lens element, molded glass lens element, and free-form surface lens element. A field of view of the optical imaging lens is greater than or equal to 100 degrees, and the optical imaging lens is a wide-angle lens.

### CROSS-REFERENCE TO RELATED APPLICATION

This application claims the priority benefit of Taiwan application serial no. 112124858, filed on Jul. 4, 2023. The entirety of the above-mentioned patent application is hereby incorporated by reference herein and made a part of this specification.

### BACKGROUND

### Technical Field

This disclosure relates to an optical device, and in particular to an optical imaging lens.

### Description of Related Art

In recent years, optical imaging lenses have continued to evolve for a wider range of applications. In addition to the requirement for thin and lightweight lenses, large field of view has gradually become the trend. In the current optical lenses, the working distance of the general lens set is mostly infinite, or from 200 mm (20 cm) to 1000 mm (1 meter) away. In the cell phone market, commonly used cell phone rear camera lenses are 60 centimeters to infinity or 30 centimeters to infinity. Therefore, if there are other special needs, multiple lenses are often used. However, once the application scenario changes, especially if the effective working distance is close (e.g., within 60 centimeters or even within 30 centimeters), the lens requirements are completely different. The disclosure relates to an optical device, and in particular to an optical imaging lens for close-range application scenarios.

In addition, in a general optical lens, the field of view of the lens group is usually between 60 degrees and 70 degrees, and its optical distortion usually falls between 10% and 20%. Therefore, how to improve the field of view while maintaining low optical distortion is one of the development goals in this field. On the other hand, in order to achieve an effective visual range (or working distance), a general lens set often uses a voice coil motor (VCM) or other zooming techniques to adjust the lens to change the effective visual range (or working distance). Therefore, how to achieve a limited visual range (or working distance) for commercial use without using additional components is also one of the development goals in this field. The disclosure relates to an optical device, and in particular to an optical imaging lens with a wide angle, high light efficiency (no additional components), and close-range application scenarios.

In terms of application, the optical imaging lens provided in the embodiments of the disclosure can be applied to contactless optical sensing devices, such as palm print recognition sensors, or limited working distance optical devices applied to contactless access control systems and health application monitoring fields.

### SUMMARY

The disclosure provides an optical imaging lens with a large field of view and good optical imaging effects, and may be adapted to limited working distance.

The disclosure provides an optical imaging lens, adapted to limited working distance, including a first lens element, a second lens element, a third lens element, a fourth lens element, a fifth lens element, a sixth lens, and an image sensing element sequentially along an optical axis from an object-side to an image-side. The first lens element to the sixth lens element each includes an object-side surface facing the object-side and an image-side surface facing the image-side. The first lens element is a wide-angle lens element. The second lens element to the sixth lens element are a combination of aspherical lens element, molded glass lens element, and free-form surface lens element. A field of view of the optical imaging lens is greater than or equal to 100 degrees, and the optical imaging lens is a wide-angle lens.

In an embodiment of the disclosure, the optical imaging lens has only six lens elements.

In an embodiment of the disclosure, the second lens element, the third lens element, and the fifth lens element are aspherical lens elements, the fourth lens element is a molded glass lens element, and the sixth lens element is a free-form surface lens element.

In an embodiment of the disclosure, the field of view of the optical imaging lens is less than 150 degrees.

In an embodiment of the disclosure, an effective working distance of the optical imaging lens is greater than or equal to 20 mm and less than or equal to 200 mm.

In an embodiment of the disclosure, an effective working distance of the optical imaging lens is greater than or equal to 100 mm and less than or equal to 500 mm.

In an embodiment of the disclosure, an effective working distance of the optical imaging lens is greater than or equal to 200 mm and less than or equal to 1000 mm.

In an embodiment of the disclosure, the optical imaging lens satisfies the following formula: CA1/TTL>0.7, where CA1 is an optical effective diameter of the first lens element, and TTL is a distance on the optical axis from the object-side surface of the first lens element to an image plane of the image sensing element.

In an embodiment of the disclosure, the optical imaging lens satisfies the following formula: SD/TTL>0.42, where SD is a diagonal length of the image plane of the image sensing element, and TTL is a distance on the optical axis from the object-side surface of the first lens element to the image sensing element.

In an embodiment of the disclosure, the optical imaging lens satisfies the following formula: 60>RWD/TTL>30, where RWD is a difference between a maximum working distance and a minimum working distance of the optical imaging lens, and TTL is a distance on the optical axis from the object-side surface of the first lens element to the image sensing element.

In an embodiment of the disclosure, the optical imaging lens further includes a filter element disposed between the sixth lens element and the image sensing element.

In an embodiment of the disclosure, the optical imaging lens has an anti-total reflection coating for a visible light band or an anti-total reflection coating for an invisible light band.

In an embodiment of the disclosure, an error value between a change in an optical deformation curve of the optical imaging lens and a tangent function of θ is less than 5% and proportional, in which 0 is the field of view of the optical imaging lens.

Based on the above, the optical imaging lens of the disclosure includes a first lens element, a second lens element, a third lens element, a fourth lens element, a fifth lens element, and a sixth lens element sequentially along an optical axis from an object-side to an image-side. The first lens element is a wide-angle lens element, and the second lens element to the sixth lens element are a combination of aspherical lens element, molded glass lens element, and free-form surface lens element. The optical imaging lens is a wide-angle lens and has a large field of view. In addition, the optical imaging lenses are adapted to limited working distance. In this way, by satisfying the above conditions for lens arrangement design and surface, the optical imaging lens may be made to have a large field of view, improved aberration, and excellent image quality, and may be adapted to limited working distances.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 is a schematic diagram of an optical imaging lens according to an embodiment of the disclosure.

FIG. 2 is a schematic diagram of a working distance of the optical imaging lens in FIG. 1.

FIG. 3 shows detailed optical data of the optical imaging lens in FIG. 1.

FIG. 4 shows aspheric surface parameters of the optical imaging lens in FIG. 1.

FIG. 5 shows free-form surface parameters of the optical imaging lens in FIG. 1.

FIG. 6 is a field curvature aberration curve diagram of the optical imaging lens in FIG. 1.

FIG. 7 is a distortion aberration curve diagram of the optical imaging lens in FIG. 1.

### DESCRIPTION OF THE EMBODIMENTS

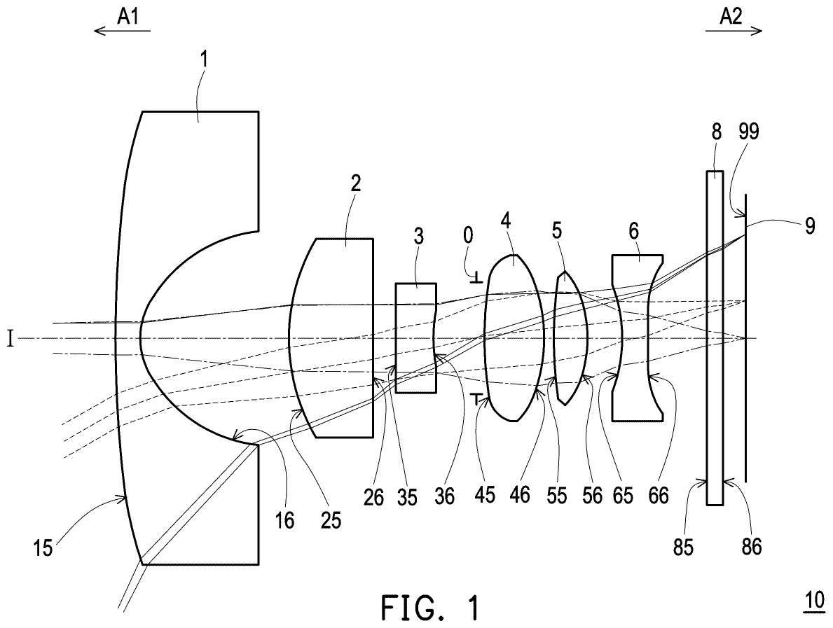

FIG. 1 is a schematic diagram of an optical imaging lens according to an embodiment of the disclosure. Please refer to FIG. 1. This embodiment provides an optical imaging lens 10 for limited working distance. A field of view of the optical imaging lens 10 is greater than or equal to 100 degrees, and the optical imaging lens 10 is a wide-angle lens. In a preferred embodiment, the field of view of the optical imaging lens 10 is greater than or equal to 100 degrees and less than 150 degrees. In terms of application, the optical imaging lens 10 provided in this embodiment can be applied to contactless optical sensing devices, such as palm print recognition sensors, or limited working distance optical devices applied to contactless access control systems, and the disclosure is not limited thereto.

The optical imaging lens 10 includes a first lens element 1, a second lens element 2, a third lens element 3, a fourth lens element 4, a fifth lens element 5, a sixth lens element 6, and an image sensing element 9 along an optical axis I from an object-side A1 to an image-side A2. When the light emitted by an object to be photographed enters the optical imaging lens 10, and passes through the first lens element 1, the second lens element 2, the third lens element 3, an aperture 0, the fourth lens element 4, the fifth lens element 5, the sixth lens element 6, and a filter element 8, an image will be formed on an image plane 99 of the image sensing element 9. The filter element 8 is disposed between an image-side surface 66 and the image plane 99 of the sixth lens element 6. It should be noted that object-side A1 is a side facing the object to be photographed, and the image-side A2 is a side facing the image plane IP. In this embodiment, the filter element 8 is, for example, an infrared cut filter (IR Cut Filter), but the disclosure is not limited thereto. In this embodiment, the optical imaging lens 10 has an anti-total reflection coating for the visible light band or an anti-total reflection coating for the invisible light band.

Specifically, in this embodiment, the first lens element 1 is a wide-angle lens element. The second lens element 2 to the sixth lens element 6 are a combination of aspherical lens element, molded glass lens element, and free-form surface lens element. The first lens element 1 to the sixth lens element 6 and the filter element 8 each include an object-side surface 15, 25, 35, 45, 55, 65, 85 facing the object-side A1 and allowing imaging light to pass through as well as an image-side surface 16, 26, 36, 46, 56, 66, 86 facing the image-side A2 and allowing the imaging light to pass through. In this embodiment, the aperture 0 is placed between the third lens element 3 and the fourth lens element 4.

Specifically, in this embodiment, the first lens element 1 is a wide-angle lens element. The first lens element 1 has negative refractive power. The object-side surface 15 of the first lens element 1 is a convex surface, and the image-side surface 16 of the first lens element 1 is a concave surface. In this embodiment, the object-side surface 15 and the image-side surface 16 of the first lens element 1 are both aspheric surfaces, but the disclosure is not limited thereto.

The second lens element 2 is an aspherical lens element. The second lens element 2 has positive refractive power. The object-side surface 25 of the second lens element 2 is a convex surface, and the image-side surface 26 of the second lens element 2 is a concave surface. In this embodiment, the object-side surface 25 and the image-side surface 26 of the second lens element 2 are both aspheric surfaces, but the disclosure is not limited thereto.

The third lens element 3 is an aspherical lens element. The third lens element 3 has negative refractive power. The object-side surface 35 of the third lens element 3 is a convex surface, and the image-side surface 36 of the third lens element 3 is a concave surface. In this embodiment, the object-side surface 35 and the image-side surface 36 of the third lens element 3 are both aspheric surfaces, but the disclosure is not limited thereto.

The fourth lens element 4 is a molded glass lens element. The fourth lens element 4 has positive refractive power. The object-side surface 45 of the fourth lens element 4 is a convex surface, and the image-side surface 46 of the fourth lens element 4 is a convex surface. In this embodiment, the object-side surface 45 and the image-side surface 46 of the fourth lens element 4 are both aspheric surfaces, but the disclosure is not limited thereto.

The fifth lens element 5 is an aspherical lens element. The fifth lens element 5 has positive refractive power. The object-side surface 55 of the fifth lens element 5 is a convex surface, and the image-side surface 56 of the fifth lens element 5 is a convex surface. In this embodiment, the object-side surface 55 and the image-side surface 56 of the fifth lens element 5 are both aspheric surfaces, but the disclosure is not limited thereto.

The sixth lens element 6 is a free-form surface lens element. The sixth lens element 6 has negative refractive power. The object-side surface 65 of the sixth lens element 6 is a concave surface, and the image-side surface 66 of the sixth lens element 6 is a concave surface. In this embodiment, the object-side surface 65 and the image-side surface 66 of the sixth lens element 6 are both free-form surfaces, but the disclosure is not limited thereto. In this embodiment, the optical imaging lens 10 has only the above six lens elements.

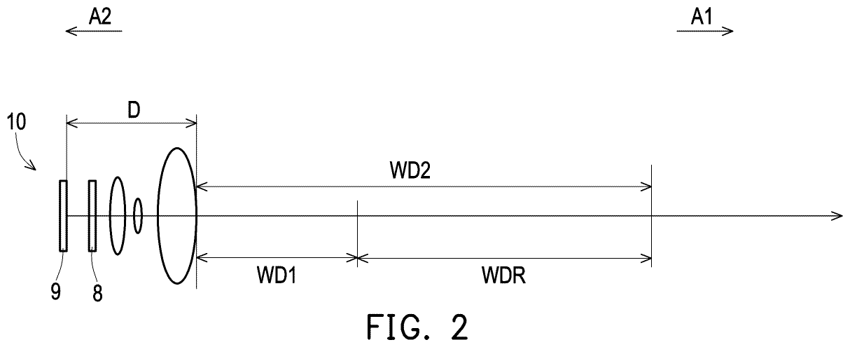

FIG. 2 is a schematic diagram of a working distance of the optical imaging lens in FIG. 1. Please refer to FIG. 1 and FIG. 2. It should be noted that in this embodiment, the optical imaging lens 10 has a minimum working distance WD1 and a maximum working distance WD2 that is not infinite, and the maximum working distance WD2 to the minimum working distance WD1 can be defined as a working distance range WDR. In this embodiment, an effective working distance of the optical imaging lens 10 is greater than or equal to 20 mm and less than or equal to 200 mm. That is, the minimum working distance WD1 is 20 mm, the maximum working distance WD2 is 200 mm, and the working distance range WDR is 180 mm. In another embodiment, the effective working distance of the optical imaging lens can also be designed to be greater than or equal to 100 mm and less than or equal to 500 mm, and the disclosure is not limited thereto. That is, the minimum working distance WD1 is 100 mm, the maximum working distance WD2 is 500 mm, and the working distance range WDR is 400 mm. In yet another embodiment, the effective working distance of the optical imaging lens can also be designed to be greater than or equal to 200 mm and less than or equal to 1000 mm, and the disclosure is not limited thereto. That is, the minimum working distance WD1 is 200 mm, the maximum working distance WD2 is 1000 mm, and the working distance range WDR is 800 mm.

In addition, when the optical imaging lens 10 satisfies the following formula, a good imaging effect may be further improved, where
the optical imaging lens 10 may comply with CA1/TTL>0.7;
the optical imaging lens 10 may comply with SD/TTL>0.42; and
the optical imaging lens 10 may comply with 60>RWD/TTL>30,
where,
CA1 is an optical effective diameter of first lens element 1;
TTL is a distance D on the optical axis I from the object-side surface 15 of the first lens element 1 to the image plane 99 of the image sensing element 9;
SD is a diagonal length of the image plane 99 of the image sensing element 9;
RWD is a difference (i.e., the working distance range WDR) between the maximum working distance WD1 and the minimum working distance WD2 of the optical imaging lens 10.

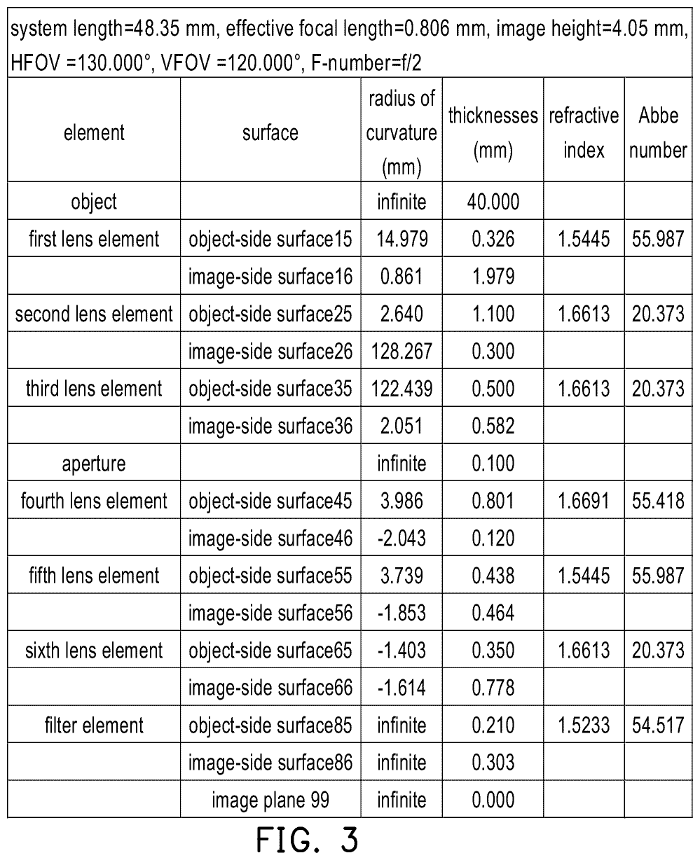

FIG. 3 shows detailed optical data of the optical imaging lens in FIG. 1. Please refer to FIG. 1 and FIG. 3. The optical imaging lens 10 of this embodiment has an effective focal length (EFL) of 0.806 millimeters (mm), a horizontal field of view (HFOV) of 130 degrees, and a vertical field of view (VFOV) is 120 degrees, a system length of 48.35 mm, a F-number of f/2, and an image height of 4.05 mm. The system length refers to a distance from the object-side surface 15 of the first lens element 1 to the image plane 99 on the optical axis I.

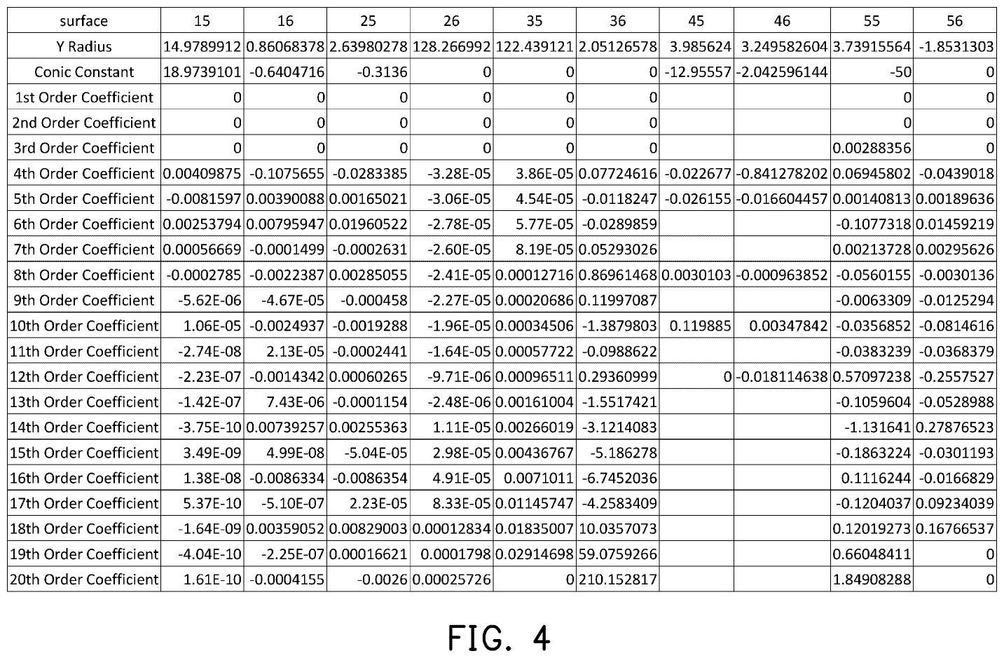

FIG. 4 shows aspheric surface parameters of the optical imaging lens in FIG. 1. Please refer to FIG. 1 and FIG. 4. In addition, in this embodiment, the object-side surfaces 15, 25, 35, 45, 55 and the image-side surfaces 16, 26, 36, 46, 56 of the first lens element 1, the second lens element 2, the third lens element 3, the fourth lens element 4, and the fifth lens element 5 are all aspheric surfaces. The object-side surfaces 15, 25, 35, 45, 55 and the image-side surfaces 16, 26, 36, 46, 56 are general even aspheric surfaces. These aspheric surfaces are defined according to the following formula (1):

$$z = \frac{{cr}^{2}}{1 + \sqrt{1 - ( 1 + k ) {c}^{2} {r}^{2}}} + AR 1 r + AR 2 {r}^{2} + AR 3 {r}^{3} + ... + {ARnr}^{n} + ... + AR 30 {r}^{30} \qquad ( 1 )$$

where:
z: a depth of the aspheric surface (a perpendicular distance between the point on the aspheric surface that is Y from the optical axis I and the tangent plane that is tangent to the vertex on the optical axis I of the aspherical plane);
c: curvature of surface vertices;
k: conic constant;
r: radial distance;
ARn: aspheric surface coefficient of rⁿ (1≤n≤30).

The various aspheric surface coefficients from the object-side surface 15 of the first lens element 1 to the image-side surface 56 of the fifth lens element 5 in formula (1) are shown in FIG. 4. Column number 15 in FIG. 4 indicates the aspheric coefficient of the object-side surface 15 of the first lens element 1, and the other columns are similar. In this embodiment and the following embodiments, the second-order aspheric surface coefficient a₂ is 0.

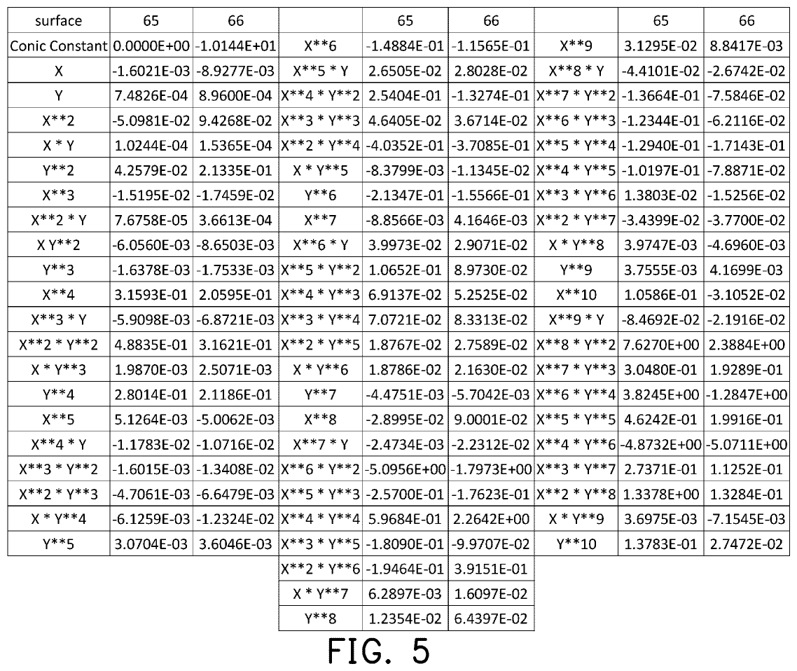

FIG. 5 shows free-form surface parameters of the optical imaging lens in FIG. 1. Please refer to FIG. 1 and FIG. 5. In addition, in this embodiment, the object-side surface 65 and the image-side surface 66 of the sixth lens element 6 are free-form surfaces, and these free-form surfaces are defined according to the following formula (2):

$$z = \frac{{cr}^{2}}{1 + \sqrt{1 - ( 1 + k ) {c}^{2} {r}^{2}}} + {\sum }_{j = 2}^{66} {C}_{j} {x}^{m} {y}^{n} j = \frac{{( m + n )}^{2} + m + 3 n}{2} + 1 \qquad ( 2 )$$

where:
z: a depth of the aspheric surface (a perpendicular distance between the point on the aspheric surface that is Y from the optical axis I and the tangent plane that is tangent to the vertex on the optical axis I of the aspherical plane);
c: curvature of surface vertices;
k: conic constant;
Cⱼ: coefficient of x^{m}yⁿ monomial.
   The various free-form surface coefficients of the object-side surface 65 and image-side surface 66 of sixth lens element 6 in formula (2) are shown in FIG. 5.

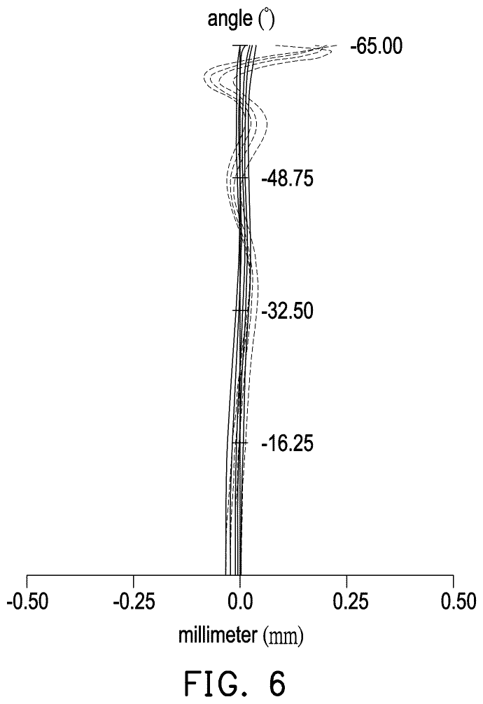

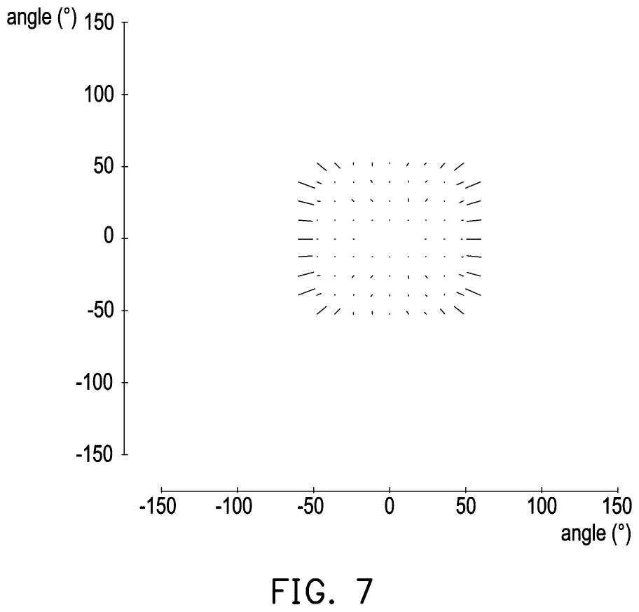

FIG. 6 is a field curvature aberration curve diagram of the optical imaging lens in FIG. 1. FIG. 7 is a distortion aberration curve diagram of the optical imaging lens in FIG. 1. Referring again to FIG. 6 and FIG. 7, FIG. 6 illustrates the field curvature aberration in the Sagittal direction and the field curvature aberration in the Tangential direction on the image plane 99 when the wavelengths of this embodiment are 435 nm, 486 nm, 546 nm, 587 nm and 656 nm, and FIG. 7 illustrates the distortion aberration on the image plane 99 when the wavelengths of this embodiment are 435 nm, 486 nm, 546 nm, 587 nm, and 656 nm. In the field curvature aberration diagram in FIG. 6, the focal length variation of the five representative wavelengths over the entire field of view falls within the range of +0.2 mm, and the field curvature aberration over a half field of view of less than 50 degrees may be further maintained within the range of +0.03 mm, which indicates that the optical system of the embodiment is capable of effectively eliminating aberration. The distortion aberration diagram in FIG. 7 shows that the distortion aberration of this embodiment is maintained within the range of ±20%, and the distortion aberration may be further maintained within ±3% at half field of view of less than 50 degrees, which indicates that the distortion aberration of the embodiment satisfies the imaging quality requirements of an optical system even at large field of view. Accordingly, the embodiment is able to provide good imaging quality under the condition of having a large field of view compared to the existing optical lens, so the embodiment is able to have a wider field of view, smaller optical aberration, and good imaging effect under the condition of having a limited working distance. It should be noted that in this embodiment, an error value between a change in an optical deformation curve of the optical imaging lens 10 and a tangent function of θ is less than 5% and proportional, in which 0 is the field of view of the optical imaging lens 10.

All embodiments of the disclosure may be practiced, and some combinations of features may be extracted from the same embodiment, and such combinations of features may be capable of achieving unanticipated results in the disclosure as compared to the prior art, and such combinations of features include, but are not limited to, combinations of facet shape, refractive power, and conditional expression. The embodiments of the disclosure are intended to illustrate specific embodiments of the principles of the disclosure and shall not be limited to the disclosed embodiments of the disclosure. Further, the embodiments and accompanying drawings are for illustrative purposes only and are not limited by them.

To sum up, the optical imaging lens of the disclosure includes a first lens element, a second lens element, a third lens element, a fourth lens element, a fifth lens element, and a sixth lens element sequentially along an optical axis from an object-side to an image-side. The first lens element is a wide-angle lens element, and the second lens element to the sixth lens element are a combination of aspherical lens element, molded glass lens element, and free-form surface lens element. The optical imaging lens is a wide-angle lens and has a large field of view. In addition, the optical imaging lenses are adapted to limited working distance. In this way, by satisfying the above conditions for lens arrangement design and surface, the optical imaging lens may be made to have a large field of view, improved aberration, and excellent image quality, and may be adapted to limited working distances.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An optical imaging lens, adapted to limited working distance, comprising a first lens element, a second lens element, a third lens element, a fourth lens element, a fifth lens element, a sixth lens, and an image sensing element sequentially along an optical axis from an object-side to an image-side, the first lens element to the sixth lens element each comprising an object-side surface facing the object-side and an image-side surface facing the image-side, wherein:
the first lens element is a wide-angle lens element;
the second lens element to the sixth lens element are a combination of aspherical lens element, molded glass lens element, and free-form surface lens element; and
a field of view of the optical imaging lens is greater than or equal to 100 degrees, and the optical imaging lens is a wide-angle lens,
an effective working distance of the optical imaging lens is greater than or equal to 20 mm and less than or equal to 200 mm, greater than or equal to 100 mm and less than or equal to 500 mm, or greater than or equal to 200 mm and less than or equal to 1000 mm.

2. The optical imaging lens according to claim 1, wherein the optical imaging lens has only six lens elements.

3. The optical imaging lens according to claim 1, wherein the second lens element, the third lens element, and the fifth lens element are aspherical lens elements, the fourth lens element is a molded glass lens element, and the sixth lens element is a free-form surface lens element.

4. The optical imaging lens according to claim 1, wherein the field of view of the optical imaging lens is less than 150 degrees.

5. The optical imaging lens according to claim 1, wherein the optical imaging lens satisfies the following formula: CA1/TTL>0.7, where CA1 is an optical effective diameter of the first lens element, and TTL is a distance on the optical axis from the object-side surface of the first lens element to an image plane of the image sensing element.

6. The optical imaging lens according to claim 1, wherein the optical imaging lens satisfies the following formula: SD/TTL>0.42, where SD is a diagonal length of the image plane of the image sensing element, and TTL is a distance on the optical axis from the object-side surface of the first lens element to the image sensing element.

7. The optical imaging lens according to claim 1, wherein the optical imaging lens satisfies the following formula: 60>RWD/TTL>30, where RWD is a difference between a maximum working distance and a minimum working distance of the optical imaging lens, and TTL is a distance on the optical axis from the object-side surface of the first lens element to the image sensing element.

8. The optical imaging lens according to claim 1, further comprising:
a filter element, disposed between the sixth lens element and the image sensing element.

9. The optical imaging lens according to claim 1, wherein the optical imaging lens has an anti-total reflection coating for a visible light band or an anti-total reflection coating for an invisible light band.

10. The optical imaging lens according to claim 1, wherein an error value between a change in an optical deformation curve of the optical imaging lens and a tangent function of θ is less than 5% and proportional, wherein 0 is the field of view of the optical imaging lens.

11. The optical imaging lens according to claim 1, further comprising:
an aperture, disposed between the third lens element and the fourth lens element, an opening of the aperture being square.

12. The optical imaging lens according to claim 1, further comprising:
an aperture, disposed between the third lens element and the fourth lens element, an opening of the aperture being polygonal.
